(19) United States
(12) Patent Application Publication
(10) Pub. No.: US 2026/0350372 A1
(43) Pub. Date: Nov. 5, 2026

(54) SOFTMAX APPROXIMATION WITH SCALED QUANTIZATION FOR EFFICIENT EXECUTION OF ATTENTION MECHANISMS

(71) Applicant: Microsoft Technology Licensing, LLC, Redmond, WA (US)

(72) Inventors: Vedula Venkata Srikant BHARADWAJ, Bellevue, WA (US); Saravanakumar RAJMOHAN, Redmond, WA (US); Victor Jonas RÜHLE, Trumpington (GB); Hao KANG, Atlanta, GA (US)

(73) Assignee: Microsoft Technology Licensing, LLC, Redmond, WA (US)

(21) Appl. No.: 19/195,246

(22) Filed: Apr. 30, 2025

(51) Int. Cl. G06N 3/048; G06F 5/01; G06F 7/556; G06F 17/18

(52) U.S. Cl. CPC G06N 3/048; G06F 5/01; G06F 7/556; G06F 17/18

(57) ABSTRACT

A data processing system implements analyzing a textual input using one or more layers of an LLM to obtain intermediate results; providing the intermediate results as an input to an attention mechanism of the LLM; analyzing the intermediate results using the attention mechanism to generate attention scores; providing the attention scores as an input to a softmax approximation framework that performs an exponentiation operation and normalization operation on the attention scores to generate a probability distribution; determining an integer portion of the exponentiation operation using the softmax approximation framework using a lookup table to determine a value for the integer portion of the exponentiation operation; determining a decimal portion of the exponentiation operation by performing a polynomial approximation to determine a value for the decimal portion of the exponentiation operation; and outputting the probability distribution from the attention mechanism to one or more additional layers of the large language model.

### BACKGROUND

Attention mechanisms improve the performance of artificial intelligence (AI) models by focusing the model on relevant information. Attention mechanisms rely on the softmax operation to convert raw attention scores into a probability distribution that ensures that the sum of the attention weights for a given token equals 1. However, softmax is a key bottleneck in the attention mechanism, particularly in flash attention workflows, where tiling operations introduce additional overhead. Experimental observations have shown the softmax computation includes over thirty percent of the attention mechanism execution time both in prefill and decoding stages. The primary performance issue stems from frequent data type conversions between half-precision floating point format (FP16) and a single precision thirty-two bit floating point format (FP32) for performing the exponentiation operation. Current graphics processing units (GPUs) are limited to FP32 operations for exponentiation, which exacerbates this bottleneck. Previous methods either introduce significant errors that degrade performance or are unsuitable for modern large language models.

### SUMMARY

An example data processing system according to the disclosure includes a processor and a memory storing executable instructions. The instructions when executed cause the processor alone or in combination with other processors to perform operations including analyzing a textual input using one or more layers of a large language model to obtain intermediate results; providing the intermediate results as an input to an attention mechanism of the large language model; analyzing the intermediate results using the attention mechanism to generate attention scores based on the intermediate results; providing the attention scores as an input to a softmax approximation framework that performs an exponentiation operation and normalization operation on the attention scores to generate a probability distribution that normalizes attention weights associated with the attention scores; determining an integer portion of the exponentiation operation using the softmax approximation framework using a lookup table (LUT) to determine a value for the integer portion of the exponentiation operation; determining a decimal portion of the exponentiation operation using the softmax approximation framework to perform a polynomial approximation to determine a value for the decimal portion of the exponentiation operation; and outputting the probability distribution from the attention mechanism to one or more additional layers of the large language model.

An example method implemented in a data processing system includes analyzing a textual input using one or more layers of a large language model to obtain intermediate results; providing the intermediate results as an input to an attention mechanism of the large language model; analyzing the intermediate results using the attention mechanism to generate attention scores based on the intermediate results; providing the attention scores as an input to a softmax approximation framework that performs an exponentiation operation and normalization operation on the attention scores to generate a probability distribution that normalizes attention weights associated with the attention scores; determining an integer portion of the exponentiation operation using the softmax approximation framework using a lookup table (LUT) to determine a value for the integer portion of the exponentiation operation; determining a decimal portion of the exponentiation operation using the softmax approximation framework to perform a polynomial approximation to determine a value for the decimal portion of the exponentiation operation; and outputting the probability distribution from the attention mechanism to one or more additional layers of the large language model.

An example machine-readable medium on which are stored instructions that, when executed, cause a processor of alone or in combination with other processors to perform operations of analyzing a textual input using one or more layers of a large language model to obtain intermediate results; providing the intermediate results as an input to an attention mechanism of the large language model; analyzing the intermediate results using the attention mechanism to generate attention scores based on the intermediate results; providing the attention scores as an input to a softmax approximation framework that performs an exponentiation operation and normalization operation on the attention scores to generate a probability distribution that normalizes attention weights associated with the attention scores; determining an integer portion of the exponentiation operation using the softmax approximation framework using a lookup table (LUT) to determine a value for the integer portion of the exponentiation operation; determining a decimal portion of the exponentiation operation using the softmax approximation framework to perform a polynomial approximation to determine a value for the decimal portion of the exponentiation operation; and outputting the probability distribution from the attention mechanism to one or more additional layers of the large language model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example softmax approximation framework according to the disclosure herein.

FIG. 2 is a diagram of an example exponentiation approximation unit of the softmax approximation framework shown in FIG. 1 according to the disclosure herein.

FIG. 3A is a diagram of an example of a single dot product attention mechanism that can utilize the softmax approximation framework disclosed herein.

FIG. 3B is a diagram of an example of a multi-head attention mechanism that can utilize the softmax approximation framework disclosed herein.

FIG. 3C is a diagram showing another example of an attention mechanism that can utilize the softmax approximation framework disclosed herein.

FIG. 4 is an example architecture of a transformer artificial intelligence model that can utilize the attention mechanisms that incorporate the softmax approximation framework disclosed herein.

FIG. 5 is a diagram of an example computing environment in which the softmax approximation framework is implemented.

FIG. 6 is a flow chart of an example process for operating an artificial intelligence model including an attention mechanism according to the techniques disclosed herein.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

Systems and methods for implementing a softmax approximation framework are provided. The softmax approximation framework provides a technical solution to the technical problems associated with the reliance on softmax operations in attention mechanisms of many artificial intelligence model. Many attention mechanisms rely on the softmax operation to convert raw attention scores into a probability distribution that ensures that the sum of the attention weights for a given token equals 1. Softmax operations include an exponentiation operation on floating point values. Current GPUs implement these exponentiation operations in the slower higher-precision FP32 computing cores rather than the faster low-precision tensor cores that can operate on FP16 data, which introduces significant latency into the attention mechanism. This approach also requires frequent conversions of data between FP16 and FP32 formats, which adds additional latency to the attention mechanism. Furthermore, this approach includes frequent use of the scratchpad memory and the register file of the compute units of the GPU, which introduces even more latency into the attention mechanism. Consequently, the softmax operation can introduce a significant bottleneck in the attention mechanism that negatively impacts the performance of the AI model. Current approaches that attempt to address these technical problems by implementing the softmax operation in the faster low-precision tensor cores of the GPU introduce inaccuracies in the attention mechanism that significantly degrade the performance of the AI model. Hence there is a need for an improved softmax approximation framework that overcomes these and other technical problems without sacrificing the accuracy of the attention mechanism and negatively impacting the performance of the AI model.

The softmax approximation framework disclosed herein provides a technical solution to the technical problems associated with current attention mechanisms by facilitating a quantized attention mechanism that can be executed on the low-precision tensor cores of the GPU and avoids the bottlenecks discussed above. The softmax approximation framework utilizes polynomial approximation (POLY) and a lookup table (LUT) to approximate the exponentiation values on the FP16 tensor core. The softmax approximation framework divides the exponentiation computation into two parts: the integer and decimal components. The software approximation framework utilizes a LUT to determine the integer part of the exponentiation value and utilizes a polynomial approximation to determine the decimal portion of the exponentiation value. The decimal component is limited to the range [0,1). Furthermore, the polynomial degree is limited to 3 or less in some implementations to reduce computational overhead. This approach provides a good fit for the polynomial approximation without introducing significant computational overhead.

The softmax approximation framework can also implement sparsification strategy to reduce the size of the LUT to further enhance computational efficiency and memory requirements. The attentions scores generated by the attention mechanism often have large negative scores resulting from query-key value multiplications which then become extremely small when the softmax operation is applied to these values due to the exponentiation inherent in the softmax operations. To implement this sparsification strategy, the softmax approximation framework retains only larger attention scores within a selected range and sets those scores that fall outside of that range to a zero value. For instance, in some implementations, the softmax approximation framework retains attention scores that fall within a range of (0, −5) and sets attention scores that fall outside this range to zero. This approach provides the technical benefit of reducing computational costs without sacrificing the accuracy of the AI model. These and other technical benefits of the techniques disclosed herein will be evident from the discussion of the example implementations that follow. Consequently, the softmax approximation framework provides a practical and efficient solution for large-scale language models.

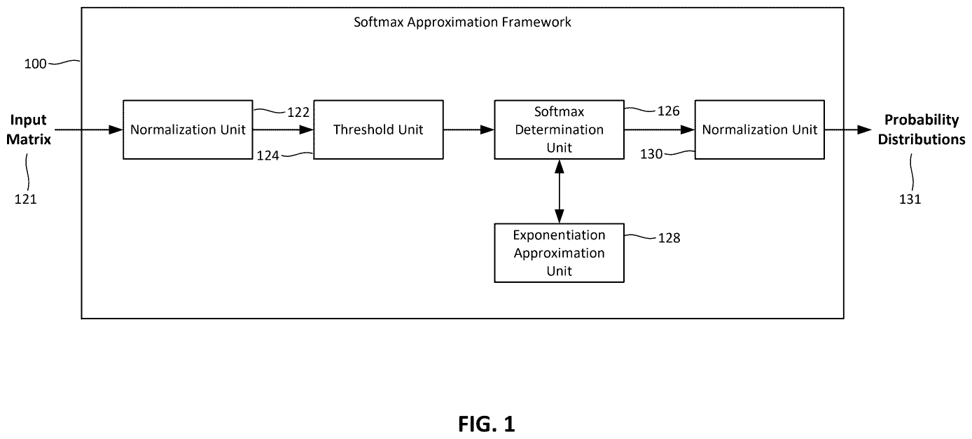

FIG. 1 is a diagram of an example softmax approximation framework according to the techniques herein. The softmax approximation framework can be implemented in the attention mechanism of a language model to significantly reduce the computational complexity and latency introduced by current softmax operations. The softmax approximation framework can be implemented in the faster low-precision FP16 tensor cores of the GPU rather than requiring the slower high-precision FP32 computing cores used to implement the exponentiation operations of current softmax operations.

The softmax approximation framework 100 receives an input matrix 121. The input matrix 121 is received from the attention mechanism of a large language model. The input matrix 121 includes attention weight determined by the attention mechanism based on the query vectors and key vectors that were provided as an input to the attention mechanism. The attention weights are values that have been determined by taking the dot product of the query vectors and key vectors of respective pairs of the key vectors that were input to the attention mechanism. The alignment between the query vectors and key vectors are used to compute the attention weights that are output by the attention mechanism. The query vector is a vector of numerical values generated from the embeddings of a current input token being processed by the attention mechanism. The key vector is a vector of numerical values that are generated from all of the input tokens. Current attention mechanisms compute the dot product of each query vector with each key vector. This results in a matrix of raw attention weights. In a typical implementation, each row of the matrix of raw attention scores represents the dot product of the query vector with one of the key vectors. However, other implementations may orient this matrix so that each column of the matrix of raw attention scores represents the dot product of the query vector with one of the key vectors. Each of the row or columns are then normalized by performing a softmax operation on the respective row or column so that the total of the values of the elements of each normalized vector equals 1.

The conventional softmax calculation can be represented by the following equation:

$${σ ( z )}_{i} = \frac{{e}^{{z}_{i}}}{{\sum }_{j = 1}^{K} {e}^{{z}_{j}}}$$

where each element zᵢ of the input vector Z consisting of K real numbers. The softmax operation normalizes the values of the elements of the input vector Z such that sum of the values of the elements of the output vector σ(Z) is 1.

The exponentiation operation in the convention softmax calculation includes exponentiation operations that require conversion from the FP16 data format of the data utilized by the attention mechanism to the FP32 data format utilized by the high-precision computation cores that perform the exponentiation operations in the GPU. The results of the exponentiation operation then must be converted back from the FP32 data format to the FP16 data format. These data conversions introduce a significant amount of latency into the attention mechanism. Furthermore, the high-precision computation cores are slower than the low-precision tensor cores that can operate on the FP16 data format, which introduces further latency into the attention mechanism. The softmax approximation framework 100 provides a technical solution to this technical problem by approximating the exponentiation operation in FP16, thereby enabling the softmax to be approximated using the faster low-precision tensors without a significant loss in accuracy of the AI model relying on the attention mechanism. The softmax approximation framework 100 provides an approximation of the softmax value according to the following relation:

e^{-x}=e^{-x}^{ᵢₙₜ}×e^{-x}^{_{dec}}≈LUT(−xᵢₙₜ)×POLY(−x_{dec})

where x represents a real number value for which an exponentiation value is to be calculated, xᵢₙₜ represents the integer component of the x value, and x_{dec} represents the decimal component of the x, LUT(xᵢₙₜ) represents a lookup table function that looks up the integer portion of the floating point value xᵢₙₜ, and POLY(X_{dec}) represents a polynomial approximation on the decimal portion of the floating point value X_{dec}.

The normalization unit 122 normalizes each row of the input matrix 121 by determining the max value for that row and subtracting the max value from each of the values in that row. In implementations in which the vectors representing the dot product of the query values are aligned along the columns of the matrix, the normalization unit 122 normalizes each column of the input matrix 121 by determining the max value for each column and subtracting the max value from each of the values in the column. The specific orientation of the input matrix 121 may vary as discussed in the preceding examples. The normalized input matrix is the provided as an input to the threshold unit 124.

The threshold unit 124 applies an integer threshold to the values of the normalized input matrix to produce a thresholded matrix. The integer threshold is a predetermined value below which each value of normalized input matrix will be discarded. In such instances, the respective value in the matrix is replaced with the integer threshold value or another threshold value. For instance, the threshold unit 124 may replace the respective value in the matrix with the integer threshold value+1 so that the floor for the values in the matrix exceeds the integer threshold value. The threshold unit 124 then provides the threshold matrix to the softmax determination unit 126 to determine an approximation of the softmax values.

The softmax determination unit 126 performs an approximated softmax operation on the thresholded matrix. The softmax determination unit 126 approximates the softmax for each row of the thresholded matrix. However, as noted above, the matrix may be oriented such that each column of the matrix represents the dot product of the query vector and a particular key vector. In such implementations, the softmax determination unit 126 approximates the softmax for each column.

The softmax determination unit 126 can implement the following algorithm to determine an approximation of the exponentiation value:

$$S ( x ) = \{ \begin{matrix}0 , & x < {n}_{r} \\ LUT ( {x}_{int} ) \times POLY ( {X}_{dec} ) , & x \geq {n}_{r}\end{matrix}$$

where x represents a floating point value to used to compute e^{x}, nᵣ is the integer threshold value imposed by the threshold unit 124, LUT(xᵢₙₜ) represents a lookup table function that looks up the integer portion of the floating point value xᵢₙₜ, and POLY(X_{dec}) represents a polynomial approximation on the decimal portion of the floating point value X_{dec}.

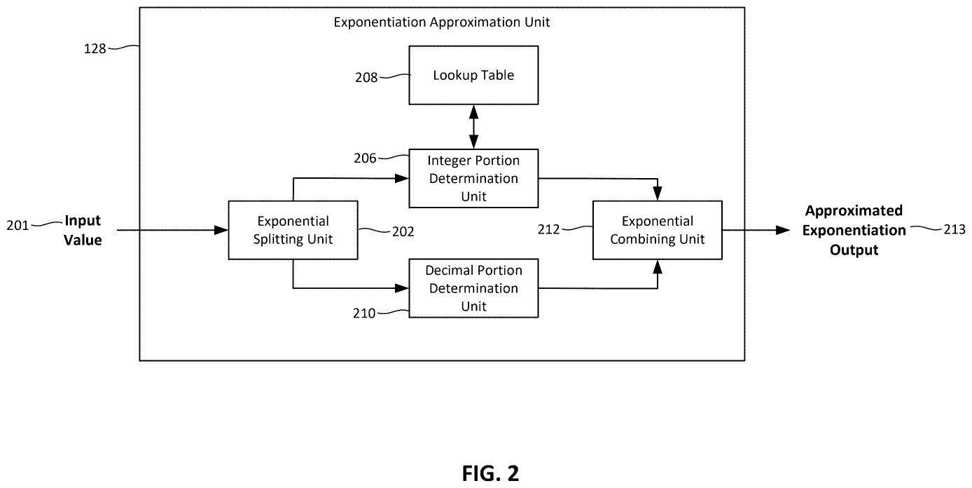

The softmax determination unit 126 determines an approximation softmax value using the exponentiation approximation unit 128 to approximate the exponentiation operations of the softmax operation. The exponentiation approximation unit 128 estimates the value of the exponentiation operation by dividing the exponent computation into integer and decimal components as shown above. The integer component is determined using a LUT and the decimal component is determined using a polynomial approximation. The softmax determination unit 126 provides a respective value from an input vector Z as an input to the exponentiation approximation unit 128 and the exponentiation approximation unit 128 determines and outputs an estimated values for the exponentiation operation. The input vector Z is either a row or column of the thresholded matrix, as discussed above, and the softmax determination unit 126 repeats this approximation for each of the rows or columns, respectively. Additional details of the exponentiation approximation unit 128 are shown in FIG. 2.

The softmax determination unit 126 determines the approximated softmax values for each of the rows of the thresholded matrix and outputs a matrix comprising an approximated softmax each row. In implementations in which the matrix is oriented such that each column of the matrix represents a particular input rather than each row, the softmax is calculated for each column. The softmax determination unit 126 provides the matrix of approximated softmax values as an input to the normalization unit 130.

The normalization unit 130 performs a normalization operation on the matrix of softmax approximations to ensure that the sum of the values of the softmax approximation equal 1 as they would in a conventional softmax operation. In implementations in which the softmax approximations are the rows of the matrix output by the softmax determination unit 126, the normalization unit 130 calculates the sum of the values of each of the elements of a row and then divides each of the elements of the row by the sum to determine the normalized value. Similarly, in implementations in which the softmax approximations are the columns of the matrix output by the softmax determination unit 126, the normalization unit 130 calculates the sum of the values of each of the elements of a column and then divides each of the elements of that column by the sum to determine the normalized value. The softmax approximation framework outputs this matrix as the probability distributions 131. The probability distributions 131 include a probability associated with each of the input tokens analyzed by the attention mechanism of the AI model.

FIG. 2 is a diagram of an example implementation of the exponentiation approximation unit 128 of the softmax approximation framework 100 according to the disclosure herein. The exponentiation approximation unit 128 receives a floating point value X as an input for which an exponentiation value e-x is to be calculated. The exponentiation approximation unit 128 determines an approximation of the exponentiation value in FP16 that can be performed in the low-precision tensors of a GPU rather than in the high-precision (FP32) processing components. A technical benefit of this approach is that the attention mechanism can be implemented in the faster low-precision tensors and avoid the latency associated with converting the FP16 values provided as an input to the softmax to FP32 values processed by the high-precision processing components, processing these inputs by the high-precision processing components, and converting the FP32 output of this computation to back to FP16 format. The exponentiation approximation unit 128 avoids this latency and computational overhead while enabling the softmax approximation framework to provide an approximation of the softmax calculation that is sufficiently accurate that the performance of the attention mechanism is not negatively impacted.

The input value 201 is provided to the exponentiation splitting unit 202, which splits the FP16 values into an integer component and a decimal component. The decimal component falls within the range [0,1), which indicates that the decimal component is greater than or equal to zero and less than one. The integer component is zero or greater. The exponentiation splitting unit provides the integer component as an input to the integer portion determination unit 206 and the decimal portion as an input to the decimal portion determination unit 210.

The integer portion determination unit 206 determines the integer portion of the exponentiation value by looking up the integer component of the input value 201 in a LUT. The LUT 208 is a compact table that maps integer values from the input value to the corresponding integer values of integer portion of the approximated exponentiation output 213. A technical benefit of this approach is that the size of the lookup table remains compact. The LUT can skip larger integer values because large values in the exponentiation operation decay quickly. The integer portion determination unit 206 provides the integer value from the LUT as an input to the exponentiation combining unit 212.

The decimal portion determination unit 210 determines the decimal portion of the exponentiation value by applying a polynomial approximation. The polynomial approximation closely approximate the values of the original exponentiation value of e^{-x}. In some implementations, to enhance computational efficiency, the decimal portion determination unit 210 utilizes a 3-degree polynomial approximation of e^{-x} to increase computational efficiency. The 3-degree polynomial approximation of e^{-x} can be represented as:

POLY(x)−0.1025x³+0.4626x²−0.9922x+0.9996

which captures the essential behavior of e^{-x} over [0, 1] with minimal computational overhead. The decimal portion determination unit 210 provides the decimal portion determined using the polynomial approximation as an input to the exponentiation combining unit 212. However, the techniques herein are not limited to 3-degree polynomial approximation. Other implementations can utilize a different degree polynomial. For instance, the degree of the polynomial approximation may be greater or less than 3. Furthermore, the coefficients utilized in the polynomial approximation can also be different than those in the 3-degree polynomial approximation shown in the example above. For instance, some implementations might utilize a 1-degree polynomial approximation with a different set of coefficients appropriate for that polynomial approximation.

The exponentiation combining unit 212 combines the integer portion and the decimal portion to generate the approximated exponentiation output 213. The exponentiation combining unit 212 multiplies the integer portion by the decimal portion to determine the approximated exponentiation output 213.

The hybrid approach taken by the exponentiation approximation unit 128 reduces computational and data type conversion overhead while preserving accuracy, effectively alleviating the exponentiation bottleneck in the attention mechanism of an AI model, such as but not limited to a single dot product attention mechanism, a multi head attention mechanism, or a flash attention mechanism.

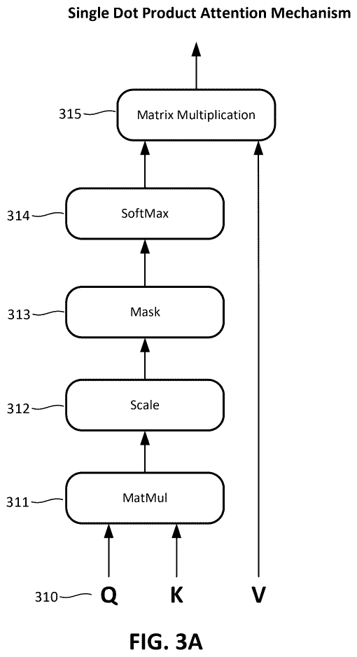

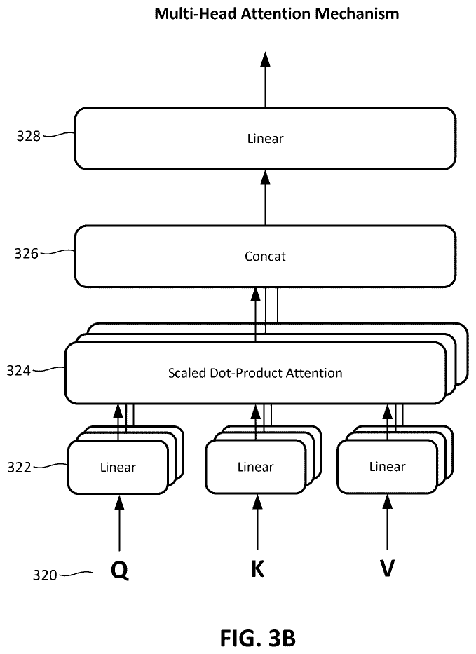

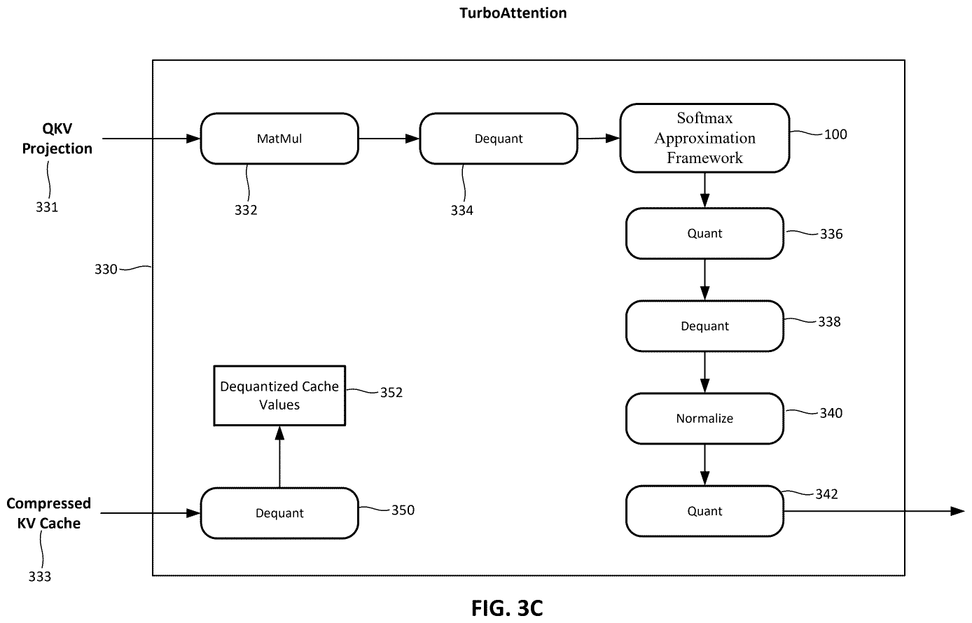

FIGS. 3A-3C are diagrams that provide examples of various types of attention mechanisms in which the softmax approximation framework 100 provided herein could be used to approximate the softmax to reduce the latency and computing resources associated with implementing such attention mechanisms. The examples shown in FIGS. 3A-3C are non-limiting and non-exhaustive. The softmax approximation framework 100 can be utilized in other attention mechanism architectures.

FIG. 3A is a diagram of an example of a single dot product attention mechanism that can utilize the softmax approximation framework disclosed herein. The single dot product attention mechanism receives inputs 310, which include a query matrix (Q), a key matrix (K), and a value matrix (V). The matrix multiplication unit 311 multiplies the query matrix and the value matrix to generate a raw attention weight matrix. The raw attention weight matrix output by the matrix multiplication unit 311 is provided as an input to the scaling unit 312. The scaling unit 312 applies a scaling factor to the raw attention weights to ensure that the attention weights do not exceed an upper or lower threshold. The output from the scaling unit 312 is optionally provided to a masking unit 313 or to the softmax unit 314 where masking unit 313 is not included. The masking unit 313 utilizes a binary tensor that signals which tokens should be considered with non-zero weights and which tokens should be ignored with a zero weight. The masks are used to ensure that the AI model focuses on meaningful information. The softmax unit 314 can be implemented by the softmax approximation framework 100 shown in FIG. 1. The softmax unit 314 receives the raw attention weight matrix as an input and outputs a normalized attention weight matrix as an output. The normalized attention weight matrix and the value matrix are provided as inputs to the matrix multiplication unit 315, and the matrix multiplication unit 315 outputs a matrix that is the weighted sum of the value vectors comprising the value matrix. The weights are determined by the normalized attention scores included in the normalized attention score matrix output by the softmax unit 314. Implementing the softmax unit 314 with the softmax approximation framework 100 shown in FIG. 1 enables the attention mechanism to be implemented in FP16 and to use the faster low-precision tensor cores to perform the exponentiation operations associated with the softmax operation. Consequently, the performance of the AI model utilizing the attention mechanism can be significantly improved by reducing latency associated with FP16 to FP32 data type conversions and the use of high-precision computing cores to perform the exponentiation operations.

FIG. 3B is a diagram of an example of a multi-head attention mechanism that can utilize the softmax approximation framework 100 disclosed herein. The multi-head attention mechanism shown in FIG. 3B builds upon the single dot product attention mechanism shown in FIG. 3A. The multi-head attention mechanism receives Q, K, and V inputs 320, which include a query matrix, a key matrix, and a value matrix as inputs, which are similar to the inputs 310 of the single dot product attention mechanism shown in FIG. 3A. However, in the multi-head attention mechanism the linear transformation unit 322 transforms the single set of Q, K, and V matrices into multiple sets of matrices referred to as heads. Each head is generated using different weight matrices to enable the attention mechanism to capture more diverse relationships and patterns in the data. The Q, K, and V matrices associated with each head are provided as separate inputs to the scaled dot product attention unit 324. Separate instances of the scaled dot product attention unit 324 may be implemented for each head. The scaled dot product attention unit 324 can be implemented using the architecture shown in FIG. 3A. The outputs from the attention units are concatenated by the concatenation unit 326 and a final weight matrix is applied by the linear transformation unit 328. The scaled dot product attention unit 324 or units can be implemented using the softmax approximation framework 100 shown in FIG. 1 to enables the attention mechanism to be implemented in FP16 and to use the faster low-precision tensor cores to perform the exponentiation operations associated with the softmax operation. As a result, the performance of the AI model utilizing the attention mechanism can be significantly improved by reducing latency associated with FP16 to FP32 data type conversions and the use of high-precision computing cores to perform the exponentiation operations.

FIG. 3C is a diagram showing another example of an attention mechanism 330 that can utilize the softmax approximation framework disclosed herein. The attention mechanism 330 shown in FIG. 3C is an example of TurboAttention architecture. The attention mechanism 330 receives QKV projection 331 as an input. The QKV projection 331 is a linear projection of the query, key, and value matrices discussed in the preceding examples. The matrix multiplication unit 332 determines intermediate activation value S, where S is:

S=Q×K^{T}

The intermediate activation value S is dequantified by the dequantification unit 334 to generate a floating point representation of the intermediate activation value S, which is provided as an input to the softmax approximation framework 100 disclosed herein. The output of the softmax approximation framework 100 is provided to the quantization unit 336 which quantizes the output of the softmax approximation framework 100 to INT8 (8 bit integer) format. The dequantization unit 338 converts the quantized values to FP32 format. The normalization unit 340 normalizes the raw weights and the normalized weights are quantized to INT8 format by the quantization unit 342.

The attention mechanism 330 utilizes the softmax approximation framework 100 to reduces the computing resources and latency associated with the softmax operation performed in the attention mechanism by enabling the softmax operation to be performed using the faster low-precision tensor cores of the GPU. The attention mechanism also receives data from a compressed KV cache 333 and dequantizes the data using the dequantization unit 350. The dequantized cache values 352 can be used by the other components of the attention mechanism 330 to perform the various operations therein.

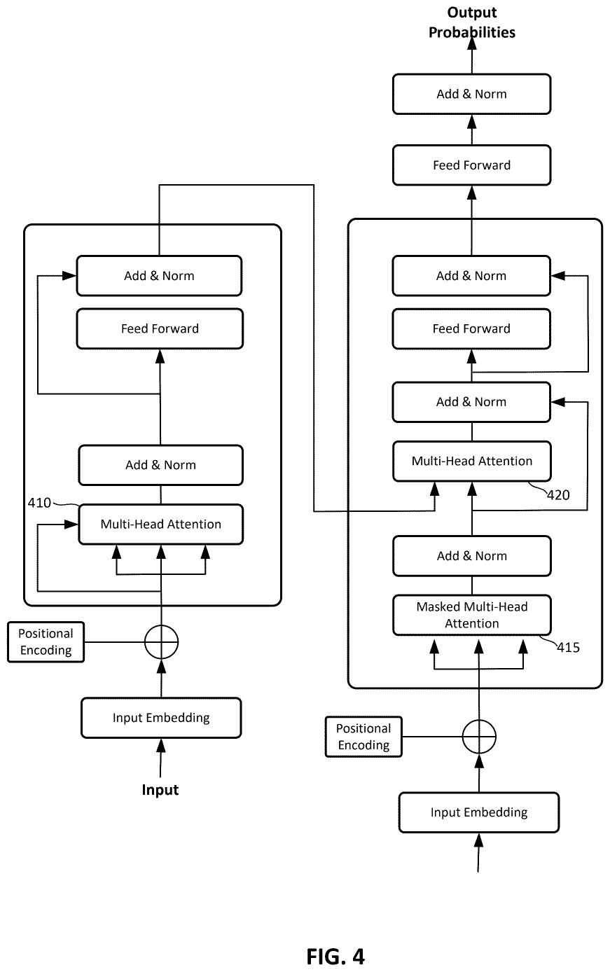

FIG. 4 is an example architecture of a transformer artificial intelligence model that can utilize the attention mechanisms that incorporate the softmax approximation framework disclosed herein. The example model architecture shown in FIG. 4 includes three attention mechanism units, unit 410, unit 415, and unit 420. Each of the attention mechanism units can utilize the softmax approximation framework 100 shown in FIG. 1 to enables the attention mechanism to be implemented in FP16 and to use the faster low-precision tensor cores to perform the exponentiation operations associated with the softmax operation. The example shown in FIG. 4 is non-limiting and other implementations can utilize other models that include attention mechanism that are implemented using the softmax approximation framework 100 to improve the performance of the model.

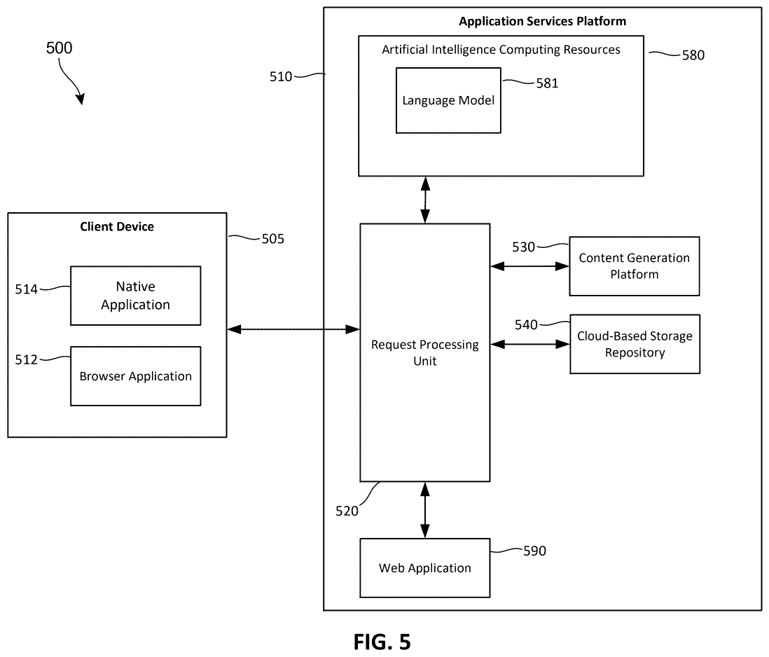

FIG. 5 is a diagram of an example computing environment 500 in which the softmax approximation framework 100 is implemented. The example computing environment 500 includes a client device 505 and an application services platform 510. The application services platform 510 may provide one or more cloud-based applications and/or provides services to support one or more web-enabled native applications on the client device 505. These applications may include but are not limited to design applications, communications platforms, visualization tools, and collaboration tools for collaboratively creating visual representations of information, and other applications for consuming and/or creating electronic content. These applications can utilize one or more language models, such as the language model 581 to generate content for the applications. The language model 581 can implement one or more attention mechanism that utilize the softmax approximation framework 100 shown in FIG. 1. The client device 505 and the application services platform 510 communicate with each other over a network (not shown). The network may be a combination of one or more public and/or private networks and may be implemented at least in part by the Internet.

The application services platform 510 can include a content generation platform 530. The content generation platform 530 provides tools that can be utilized by the native application 514 and/or the web application 590 to generate content utilizing the language model 581 and/or other AI models implemented by the application services platform 510. The content generation platform 530 is configured to construct prompts instructing the language model 581 and/or other AI models to generate specific content in response to requests from the native application 514 and/or the web application 590. The content generation platform 530 provides the requested content received from the model to the native application 514 and/or the web application 590.

The application services platform 510 may also include a cloud-based storage repository 540. The cloud-based storage repository may implement an AI-enabled search that utilizes an AI model implemented on the application services platform 510 that includes an attention mechanism that utilizes the softmax approximation framework 100.

The request processing unit 520 receives requests from an application implemented by the native application 514 of the client device 505 and/or the web application 590 of the application services platform 510. The native application 514 and/or the web application 590 provide one or more user interfaces that enables users to view, create, and/or modify electronic content. The request processing unit 520 also coordinates communication and exchange of data among components of the application services platform 510.

The AI computing resources 580 provide a computing environment that allocates and operates computing resources for one or more AI models. These models can include the language model 581 and/or additional AI models that can be used to generate various types of content. The language model 581 and/or the other AI models can include an attention mechanism that implements the softmax approximation framework 100 to reduce the computational requirements of the attention mechanism and/or latency associated with the attention mechanism. Consequently, the performance of the language model 581 and/or the other AI models can be significantly increased without negatively impacting the performance of the language model 581 and/or the other AI models.

The client device 505 is a computing device that may be implemented as a portable electronic device, such as a mobile phone, a tablet computer, a laptop computer, a portable digital assistant device, a portable game console, and/or other such devices in some implementations. The client device 505 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 5 includes a single client device, other implementations may include a different number of client devices that utilize services provided by the application services platform 510.

The client device 505 includes a native application 514 and a browser application 512. The native application 514 is a web-enabled native application, in some implementations, that enables users to view, create, and/or modify electronic content. The web-enabled native application utilizes services provided by the application services platform 510 including but not limited to creating, viewing, and/or modifying various types of electronic content. In other implementations, the browser application 512 is used for accessing and viewing web-based content provided by the application services platform 510. In such implementations, the application services platform 510 implements one or more web applications, such as the web application 590, that enables users to view, create, and/or modify electronic content. The application services platform 510 supports both web-enabled native applications and a web application in some implementations, and the users may choose which approach best suits their needs.

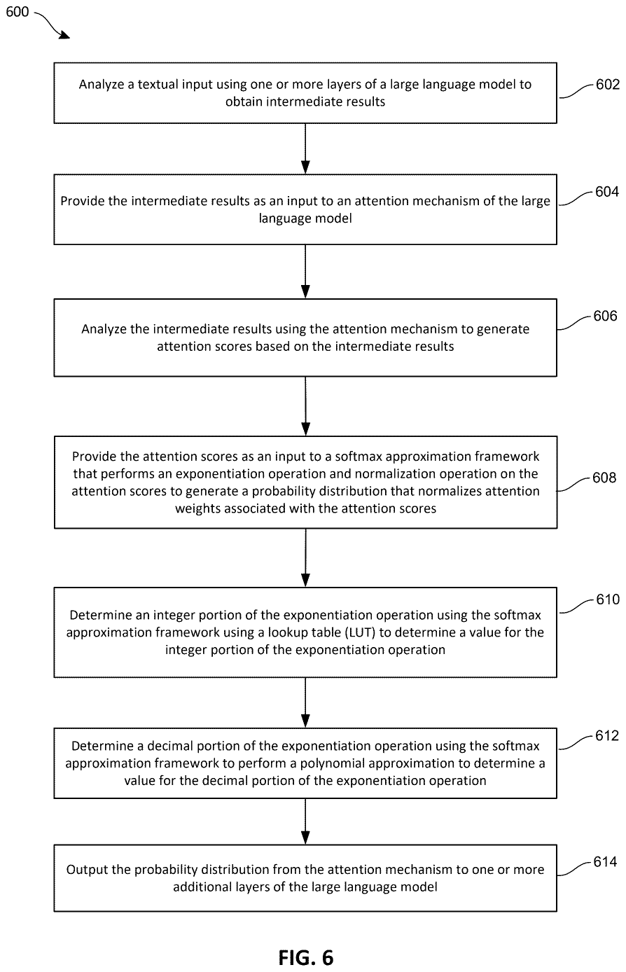

FIG. 6 is a flow chart of an example process 600 for operating an artificial intelligence model including an attention mechanism according to the techniques disclosed herein. The process 600 can be implemented, in part, by the softmax approximation framework 100 shown in FIG. 1. The softmax approximation framework can be implemented by the attention mechanism of a language model.

The process 600 includes an operation 602 of analyzing a textual input using one or more layers of a large language model to obtain intermediate results, an operation 604 of providing the intermediate results as an input to an attention mechanism of the large language model, and an operation 606 of analyzing the intermediate results using the attention mechanism to generate attention scores based on the intermediate results. The language model can receive an input or inputs and analyze these input or inputs using one or more layers that analyze the input and/or data derived therefrom to generate intermediate results. The intermediate results may include query, key, and value matrices as discussed in the preceding examples, which are provided as an input to an attention mechanism, such as but not limited to the example attention mechanisms shown in FIGS. 3A-3C. Furthermore, while FIG. 4 provides a non-limiting example of one language model architecture that implements attention mechanisms that can utilize the softmax approximation framework 100 shown in FIG. 1, other implementations can utilize a different language model architecture that implements an attention mechanism that can utilize the softmax approximation framework 100 shown in FIG. 1.

The process 600 includes an operation 608 of providing the attention scores as an input to a softmax approximation framework 100 that performs an exponentiation operation and normalization operation on the attention scores to generate a probability distribution that normalizes attention weights associated with the attention scores. FIGS. 1 and 2 provide an example of the softmax approximation framework 100 and the exponentiation approximation unit 128 of the softmax approximation framework 100 that implements the exponentiation operation.

The process 600 includes an operation 610 of determining an integer portion of the exponentiation operation using the softmax approximation framework using a LUT to determine a value for the integer portion of the exponentiation operation. As discussed in the preceding examples, the exponentiation approximation unit 128 of the softmax approximation framework 100 divides the exponentiation operation into an integer portion and a decimal portion. The exponentiation approximation unit 128 determines the value for the integer portion using a LUT to reduce the computational complexity of the operation as well as the memory requirements, which enables the exponentiation operation to be performed by the low-precision tensors in FP16 format.

The process 600 includes an operation 612 of determining a decimal portion of the exponentiation operation using the softmax approximation framework to perform a polynomial approximation to determine a value for the decimal portion of the exponentiation operation. The exponentiation approximation unit 128 determines the value for the decimal portion using a polynomial approximation. This approach also reduces the computational complexity of the attention mechanism while producing a close approximation of what the results would be in an implementation that uses conventional softmax that performs exponentiation using the high-precision tensors without negatively impacting accuracy of the attention mechanism and the performance of the language model.

The process 600 includes an operation 614 of outputting the probability distribution from the attention mechanism to one or more additional layers of the large language model. The probability distribution output by the attention mechanism includes the attention weights generated by the attention mechanism and normalized by the softmax approximation framework 100. The attention weights may be subjected to further processing by one or more additional layers of the language model. The specific processing that is performed is dependent at least in part on the architecture of the specific model.

The detailed examples of systems, devices, and techniques described in connection with FIGS. 1-6 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

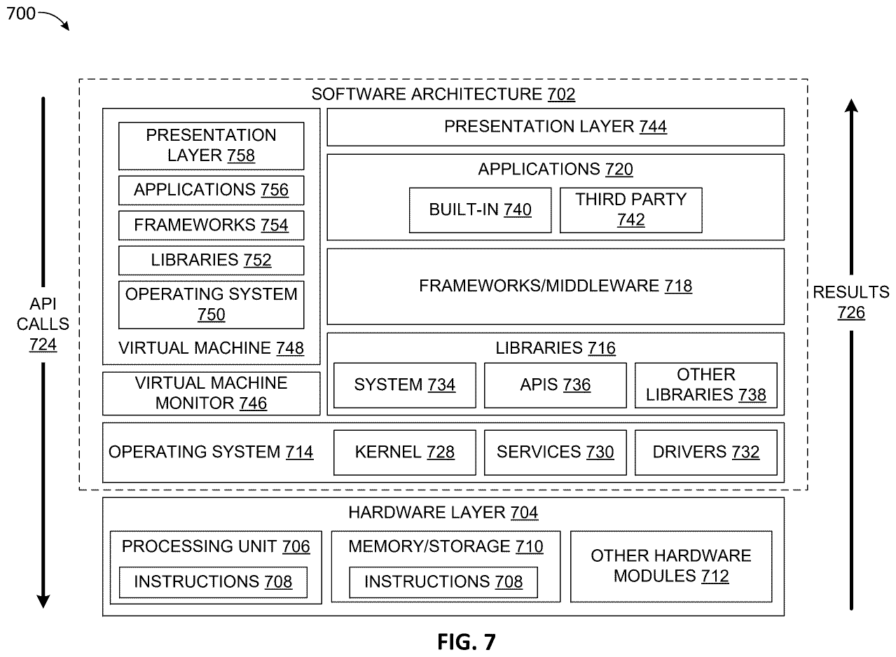

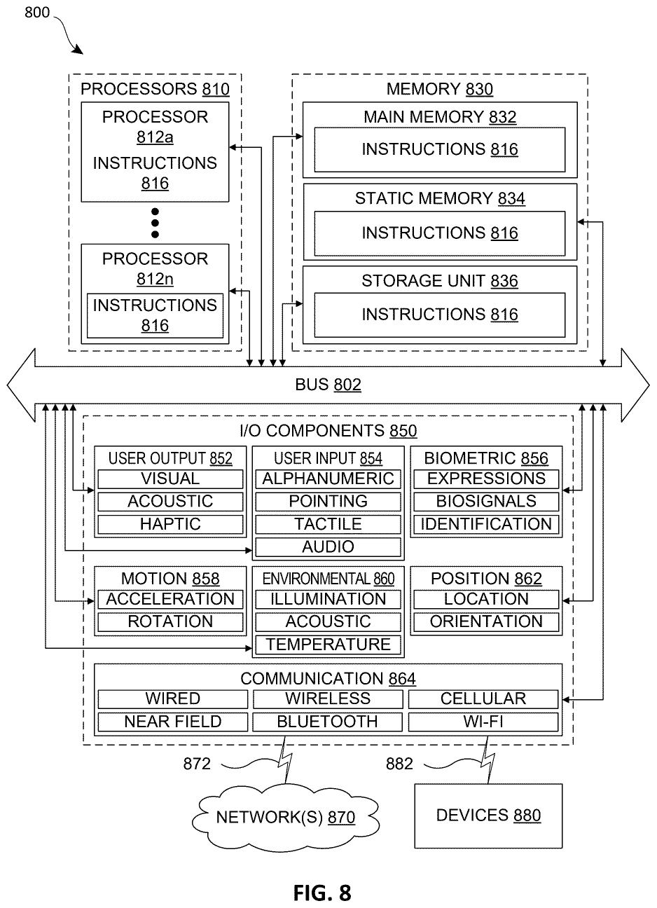

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory/storage, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks/middleware 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks/middleware 718 provide a higher-level common infrastructure that may be used by the applications 720 and/or other software modules. For example, the frameworks/middleware 718 may provide various graphic user interface (GUI) functions, high-level resource management, or high-level location services. The frameworks/middleware 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks/middleware 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory/storage 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multicore processor including cores that may execute instructions contemporaneously. Although FIG. 8 shows multiple processors, the machine 800 may include a single processor with a single core, a single processor with multiple cores (for example, a multicore processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirements of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
analyzing a textual input using one or more layers of a large language model to obtain intermediate results;
providing the intermediate results as an input to an attention mechanism of the large language model;
analyzing the intermediate results using the attention mechanism to generate attention scores based on the intermediate results;
providing the attention scores as an input to a softmax approximation framework that performs an exponentiation operation and normalization operation on the attention scores to generate a probability distribution that normalizes attention weights associated with the attention scores;
determining an integer portion of the exponentiation operation using the softmax approximation framework using a lookup table (LUT) to determine a value for the integer portion of the exponentiation operation;
determining a decimal portion of the exponentiation operation using the softmax approximation framework to perform a polynomial approximation to determine a value for the decimal portion of the exponentiation operation; and
outputting the probability distribution from the attention mechanism to one or more additional layers of the large language model.

2. The data processing system of claim 1, wherein the probability distribution normalizes attention weights to sum to a value of 1.

3. The data processing system of claim 1, wherein the softmax approximation framework is configured to perform the exponentiation operation for each attention score by performing, for a respective attention score, operations including:
dividing the respective attention score into an integer component and a decimal component;
determining an intermediate integer value based on the integer component by looking up the integer component in the LUT that maps integer values to the intermediate integer value;
determining an intermediate decimal value using polynomial approximation on the decimal component of the respective attention score; and
multiplying the intermediate integer value and the intermediate decimal value to generate an unnormalized probability value for the respective attention score.

4. The data processing system of claim 3, wherein the lookup table includes a set of ranges of input integer values, wherein each range maps to an output values for the integer component.

5. The data processing system of claim 3, wherein the softmax approximation framework is configured to perform the normalization operation by performing operations including:
accessing, from a memory of the data processing system, the unnormalized probability value associated with each of the attention scores;
determining a sum of the unnormalized probability value associated with each of the attention scores; and
dividing each unnormalized probability value by the sum to determine a normalized probability value.

6. The data processing system of claim 1, wherein the attention scores are represented by a matrix comprising values determined by multiplying query values and key values input to the attention mechanism, and wherein the memory further stores executable instructions that, when executed, cause the processor alone or in combination with other processors to perform operations of:
normalize values in the matrix by determining a maximum value for each row of the matrix and subtracting the maximum value from the matrix prior to performing the exponentiation operation on each attention score.

7. The data processing system of claim 1, wherein the memory further stores executable instructions that, when executed, cause the processor alone or in combination with other processors to perform operations of:
applying a sparsity threshold value to the attention scores in which each attention score is set to zero that does not satisfy the sparsity threshold value.

8. The data processing system of claim 1, wherein the memory further stores executable instructions that, when executed, cause the processor alone or in combination with other processors to perform operations of:
maintaining a polynomial degree of the polynomial approximation at a threshold degree; and
determining coefficients of the polynomial approximation utilizing a least squares method.

9. The data processing system of claim 1, wherein the memory further stores executable instructions that, when executed, cause the processor alone or in combination with other processors to perform operations of:
maintaining a polynomial degree of the polynomial approximation at a threshold degree; and
determining coefficients of the polynomial approximation utilizing a least squares method.

10. The data processing system of claim 1, wherein the memory further stores executable instructions that, when executed, cause the processor alone or in combination with other processors to perform operations of:
performing the exponentiation operation in half-precision floating-point format.

11. The data processing system of claim 1, wherein the attention mechanism comprises a multi head attention mechanism, and wherein each head of the multi head attention mechanism provides a subset of the attention scores as an input to the softmax approximation framework.

12. A method implemented in a data processing system for approximating a softmax operation in an attention mechanism, the method comprising:
analyzing a textual input using one or more layers of a large language model to obtain intermediate results;
providing the intermediate results as an input to an attention mechanism of the large language model;
analyzing the intermediate results using the attention mechanism to generate attention scores based on the intermediate results;
providing the attention scores as an input to a softmax approximation framework that performs an exponentiation operation and normalization operation on the attention scores to generate a probability distribution that normalizes attention weights associated with the attention scores;
determining an integer portion of the exponentiation operation using the softmax approximation framework using a lookup table (LUT) to determine a value for the integer portion of the exponentiation operation;
determining a decimal portion of the exponentiation operation using the softmax approximation framework to perform a polynomial approximation to determine a value for the decimal portion of the exponentiation operation; and
outputting the probability distribution from the attention mechanism to one or more additional layers of the large language model.

13. The method of claim 12, wherein the probability distribution normalizes attention weights to sum to a value of 1.

14. The method of claim 12, wherein performing the exponentiation operation for each attention score using the softmax approximation framework by performing, for a respective attention score, operations including:
dividing the respective attention score into an integer component and a decimal component;
determining an intermediate integer value based on the integer component by looking up the integer component in a lookup table (LUT) that maps integer values to the intermediate integer value;
determining an intermediate decimal value using polynomial approximation on the decimal component of the respective attention score; and
multiplying the intermediate integer value and the intermediate decimal value to generate an unnormalized probability value for the respective attention score.

15. The method of claim 14, wherein the lookup table includes a set of ranges of input integer values, wherein each range maps to an output values for the integer component.

16. The method of claim 14, wherein performing the normalization operation with the softmax approximation framework includes operations of:
accessing, from a memory of the data processing system, the unnormalized probability value associated with each of the attention scores;
determining a sum of the unnormalized probability value associated with each of the attention scores; and
dividing each unnormalized probability value by the sum to determine a normalized probability value.

17. The method of claim 14, wherein the attention scores are represented by a matrix comprising values determined by multiplying query values and key values input to the attention mechanism, and the method further comprising:
normalize values in the matrix by determining a maximum value for each row of the matrix and subtracting the maximum value from the matrix prior to performing the exponentiation operation on each attention score.

18. A machine-readable medium on which are stored instructions that, when executed, cause a processor of alone or in combination with other processors to perform operations of:
analyzing a textual input using one or more layers of a large language model to obtain intermediate results;
providing the intermediate results as an input to an attention mechanism of the large language model;
analyzing the intermediate results using the attention mechanism to generate attention scores based on the intermediate results;
providing the attention scores as an input to a softmax approximation framework that performs an exponentiation operation and normalization operation on the attention scores to generate a probability distribution that normalizes attention weights associated with the attention scores;
determining an integer portion of the exponentiation operation using the softmax approximation framework using a lookup table (LUT) to determine a value for the integer portion of the exponentiation operation;
determining a decimal portion of the exponentiation operation using the softmax approximation framework to perform a polynomial approximation to determine a value for the decimal portion of the exponentiation operation; and
outputting the probability distribution from the attention mechanism to one or more additional layers of the large language model.

19. The machine-readable medium of claim 18, wherein the softmax approximation framework is configured to perform the exponentiation operation for each attention score by performing, for a respective attention score, operations including:
dividing the respective attention score into an integer component and a decimal component;
determining an intermediate integer value based on the integer component by looking up the integer component in a lookup table (LUT) that maps integer values to the intermediate integer value;
determining an intermediate decimal value using polynomial approximation on the decimal component of the respective attention score; and
multiplying the intermediate integer value and the intermediate decimal value to generate an unnormalized probability value for the respective attention score.

20. The machine-readable medium of claim 19, wherein the lookup table includes a set of ranges of input integer values, wherein each range maps to an output values for the integer component.
